(19) United States
(12) Patent Application Publication
(10) Pub. No.: US 2014/0062988 A1
(43) Pub. Date: Mar. 6, 2014

(54) ORGANIC LIGHT EMITTING DIODE DISPLAY AND DRIVING METHOD THEREOF

(71) Applicants: Dong Hwan LEE, Yongin-City (KR); Seung Kyun HONG, Yongin-City (KR); So Young PARK, Yongin-City (KR)

(72) Inventors: Dong Hwan LEE, Yongin-City (KR); Seung Kyun HONG, Yongin-City (KR); So Young PARK, Yongin-City (KR)

(21) Appl. No.: 13/917,749

(22) Filed: Jun. 14, 2013

(30) Foreign Application Priority Data
Aug. 29, 2012 (KR) 10-2012-0095161

(51) Int. Cl. G09G 3/32

(52) U.S. Cl. CPC G09G 3/3208
USPC 345/212; 345/82

(57) ABSTRACT

An organic light emitting diode display includes at least one pixel circuit, a scanning drive unit connected to the pixel circuit through a scan line and generating a selection signal to be applied to the pixel circuit, and a data drive unit connected to the pixel circuit through a data line and applying a data voltage to the pixel circuit. The data drive unit includes a first line to which the data voltage is applied and a demultiplexer connected between the first line and a first end of the data line, the demultiplexer time-divisionally applying the data voltage applied to the first line to the data line according to a demultiplexing signal. In one horizontal cycle, at least a portion of a period in which the demultiplexing signal is applied and at least a portion of a period in which the selection signal is applied overlap each other.

### CROSS-REFERENCE TO RELATED APPLICATION

This application claims priority from Korean Patent Application No. 10-2012-0095161 filed on Aug. 29, 2012 in the Korean Intellectual Property Office, and all the benefits accruing therefrom under 35 U.S.C. 119, the contents of which in its entirety are herein incorporated by reference.

### BACKGROUND

1. Field

The present inventive concept relates to an organic light emitting diode display and a driving method thereof.

2. Description of the Related Art

An organic light emitting diode display is a display device that emits light by electrically exciting organic compounds and represents an image by driving a plurality of organic light emitting elements arranged in a matrix. When the organic light emitting element has diode characteristics, it is referred to as an organic light emitting diode (OLED). Generally, the organic light emitting element has a structure of an anode electrode layer, an organic thin film, and a cathode electrode layer. In the organic light emitting element, holes and electrons injected through the anode electrode and the cathode electrode are combined in the organic thin film to emit light. The methods of driving the organic light emitting element may be divided into a voltage programming method and a current programming method according to the type of a signal which is applied.

When thin film transistors formed in a plurality of pixels in which organic light emitting elements are respectively formed, a deviation of a threshold voltage occurs due to the non-uniformity of a manufacturing process. Accordingly, in the voltage programming method, it may be difficult to obtain a high gradation due to a deviation of the threshold voltage of the thin film transistors.

Therefore, in order to obtain the high gradation, an organic light emitting diode display capable of compensating for a deviation of the threshold voltage of drive transistors has been developed. Further, with the development of the technology, organic light emitting diode displays in which the resolution and the driving frequency are increased have emerged.

### SUMMARY

One or more embodiments are directed to an organic light emitting diode display, comprising at least one pixel circuit, a scanning drive unit which is connected to the pixel circuit through a scan line, and generates a selection signal to be applied to the pixel circuit, and a data drive unit which is connected to the pixel circuit through a data line, and applies a data voltage to the pixel circuit, wherein the data drive unit includes a first line to which the data voltage is applied, and a demultiplexer which is connected between the first line and one end of the data line to time-divisionally apply the data voltage applied to the first line to the data line according to a demultiplexing signal, and wherein in one horizontal cycle, at least a portion of a period in which the demultiplexing signal is applied and at least a portion of a period in which the selection signal is applied overlap each other.

In the one horizontal cycle, a start point of a period in which the selection signal is applied may be equal to or prior to a start point of any period among at least one period in which the demultiplexing signal is applied, and an end point of a period in which the selection signal is applied may be equal to or later than an end point of the last period among at least one period in which the demultiplexing signal is applied.

The scan line may include a first scan line to which a first selection signal is applied and a second scan line to which a second selection signal is applied before the first selection signal is applied to the first scan line, and wherein a negative voltage or ground voltage is applied to the data line before a period in which the first selection signal is applied after a period in which the second selection signal is applied.

The scan line may include a first scan line to which a first selection signal is applied and a second scan line to which a second selection signal is applied before the first selection signal is applied to the first scan line, wherein a negative voltage or ground voltage is applied to the first line before a period in which the first selection signal is applied after a period in which the second selection signal is applied, and wherein the demultiplexing signal is applied to the demultiplexer before the period in which the first selection signal is applied after the period in which the second selection signal is applied.

The organic light emitting diode display may further include a light emission control drive unit connected to the pixel circuit through a light emission control line and generates a light emission control signal to be applied to the pixel circuit, a second line which is connected to the pixel circuit, and to which a first voltage is applied, a third line which is connected to the pixel circuit, and to which a second voltage is applied, and a fourth line which is connected to the pixel circuit, and to which a third voltage is applied, wherein the scan line includes a first scan line to which a first selection signal is applied and a second scan line to which a second selection signal is applied before the first selection signal is applied to the first scan line, and wherein the pixel circuit includes a first switching element, a first electrode of which is connected to the second line, and a gate electrode of which is connected to the light emission control line, a second switching element, a first electrode of which is connected to a second electrode of the first switching element, a third switching element, a first electrode of which is connected to a second electrode of the second switching element, and a gate electrode of which is connected to the light emission control line, an organic light emitting element, one end of which is connected to a second electrode of the third switching element, and the other end of which is connected to the third line to which the second voltage is applied, a fourth switching element, a first electrode of which is connected to the second electrode of the second switching element, a gate electrode of which is connected to the first scan line, and a second electrode of which is connected to a gate electrode of the second switching element, a first capacitor, one end of which is connected to the second line, and the other end of which is connected to the gate electrode of the second switching element, a fifth switching element, a first electrode of which is connected to the gate electrode of the second switching element, a gate electrode of which is connected to the second scan line, and a second electrode of which is connected to the fourth line, and a sixth switching element, a first electrode of which is connected to a first electrode of the second switching element, a gate electrode of which is connected to the first scan line, and a second electrode of which is connected to the data line.

The data drive unit may further include a fifth line to which a fourth voltage is applied, and a seventh switching element, a first electrode of which is connected to the other end of the data line, and a second electrode of which is connected to the fifth line.

A control signal may be applied to a gate electrode of the seventh switching element before a period in which the first selection signal is applied after a period in which the second selection signal is applied.

The fourth voltage may be applied to the data line when a control signal is applied to the gate electrode of the seventh switching element.

The first voltage may be a bipolar voltage, the second voltage is a negative voltage or ground voltage, the third voltage is a negative voltage or ground voltage, and the fourth voltage is a negative voltage or ground voltage.

The first switching element to the seventh switching element may be p-channel metal oxide semiconductor (PMOS) transistors.

The organic light emitting diode display may further include a second capacitor, one end of which is connected to the gate electrode of the second switching element, and the other end of which is connected to the first scan line.

The organic light emitting diode display may further include a third capacitor, one end of which is connected to the second line, and the other end of which is connected to the data line.

The organic light emitting diode display may further include a light emission control drive unit which is connected to the pixel circuit through a light emission control line and generates a light emission control signal to be applied to the pixel circuit, a second line which is connected to the pixel circuit, and to which a first voltage is applied, and a third line which is connected to the pixel circuit, and to which a second voltage is applied, wherein the data drive unit further includes a seventh switching element, a first electrode of which is connected to the other end of the data line, and a second electrode of which is connected to the second line, wherein the scan line includes a first scan line to which a first selection signal is applied and a second scan line to which a second selection signal is applied before the first selection signal is applied to the first scan line, and wherein the pixel circuit may include a first switching element, a first electrode of which is connected to the second line, and a gate electrode of which is connected to the light emission control line, a second switching element, a first electrode of which is connected to a second electrode of the first switching element, a third switching element, a first electrode of which is connected to a second electrode of the second switching element, and a gate electrode of which is connected to the light emission control line, an organic light emitting element, one end of which is connected to a second electrode of the third switching element, and the other end of which is connected to the third line to which the second voltage is applied, a fourth switching element, a first electrode of which is connected to the second electrode of the second switching element, a gate electrode of which is connected to the first scan line, and a second electrode of which is connected to a gate electrode of the second switching element, a first capacitor, one end of which is connected to the second line, and the other end of which is connected to the gate electrode of the second switching element, a fifth switching element, a first electrode of which is connected to the gate electrode of the second switching element, a gate electrode of which is connected to the second scan line, and a second electrode of which is connected to the second line; and a sixth switching element, a first electrode of which is connected to a first electrode of the second switching element, a gate electrode of which is connected to the first scan line, and a second electrode of which is connected to the data line.

The organic light emitting diode display may further include a storage capacitor whose stored voltage is initialized according to a first selection signal, and a data line which is connected to the storage capacitor, and to which a data voltage is applied according to a demultiplexing signal, wherein the storage capacitor stores the data voltage applied to the data line according to a second selection signal, and wherein in one horizontal cycle, at least a portion of a period in which the demultiplexing signal is applied and at least a portion of a period in which the first selection signal or the second selection signal is applied overlap each other.

One or more embodiments are directed a driving to a method of an organic light emitting diode display, including initializing a voltage stored in a capacitor included in a pixel circuit according to a first selection signal, applying a data voltage to a data line according to a demultiplexing signal, and storing the data voltage applied to the data line in the capacitor according to a second selection signal, wherein in one horizontal cycle, at least a portion of a period in which the demultiplexing signal is applied and at least a portion of a period in which the first selection signal or the second selection signal is applied overlap each other.

The driving method may further include, before storing the data voltage in the capacitor after initializing the voltage stored in the capacitor, applying a negative voltage or ground voltage to the data line.

Applying the data voltage to the data line may include applying a negative voltage or ground voltage to the data line according to a first demultiplexing signal, and applying a data voltage representing a gradation to the data line according to a second demultiplexing signal, wherein in the one horizontal cycle, at least a portion of a period in which the second demultiplexing signal is applied and at least a portion of a period in which the first selection signal or the second selection signal is applied overlap each other.

One or more embodiments are directed to a driving method of an organic light emitting diode display, further comprising, before storing the data voltage in the capacitor after initializing the voltage stored in the capacitor, applying a negative voltage or ground voltage to the data line according to the first demultiplexing signal.

### BRIEF DESCRIPTION OF THE DRAWINGS

The above and other aspects and features will become more apparent by describing in detail exemplary embodiments thereof with reference to the attached drawings, in which:

FIG. 1 is a circuit diagram showing an entire configuration of an organic light emitting diode display in accordance with an embodiment;

FIG. 2 is a circuit diagram showing a configuration of one pixel circuit of an organic light emitting diode display in accordance with a first embodiment;

FIG. 3 is a waveform diagram showing drive signal timings for the organic light emitting diode display in accordance with the first embodiment;

FIG. 4 is a waveform diagram showing drive signal timings for one pixel of the organic light emitting diode display in accordance with the first embodiment;

FIG. 5 is a circuit diagram for explaining the operation of the pixel circuit in response to the drive signals of the first embodiment;

FIG. 6 is a circuit diagram for explaining the operation of the pixel circuit in response to the drive signals of the first embodiment;

FIG. 7 is a circuit diagram for explaining the operation of the pixel circuit in response to the drive signals of the first embodiment;

FIG. 8 is a time-voltage graph for explaining the effect of the organic light emitting diode display in accordance with the first embodiment;

FIG. 9 is a circuit diagram showing a configuration of one pixel circuit of an organic light emitting diode display in accordance with a second embodiment;

FIG. 10 is a waveform diagram showing drive signal timings for the organic light emitting diode display in accordance with the second embodiment;

FIG. 11 is a circuit diagram showing a configuration of one pixel circuit of an organic light emitting diode display in accordance with a third embodiment; and

FIG. 12 is a circuit diagram showing a configuration of one pixel circuit of an organic light emitting diode display in accordance with a fourth embodiment.

### DETAILED DESCRIPTION

Advantages and features of embodiments and methods of accomplishing the same may be understood more readily by reference to the following detailed description of preferred embodiments and the accompanying drawings. The embodiments may, however, be embodied in many different forms and should not be construed as being limited to the embodiments set forth herein. Rather, these embodiments are provided so that this disclosure will be thorough and complete and will fully convey the concept of to those skilled in the art, and the present invention will only be defined by the appended claims. Thus, in some embodiments, well-known structures and devices are not shown in order not to obscure the description of the embodiments with unnecessary detail. Like numbers refer to like elements throughout. In the drawings, the thickness of layers and regions are exaggerated for clarity.

It will be understood that when an element or layer is referred to as being “on,” or “connected to” another element or layer, it can be directly on or connected to the other element or layer or intervening elements or layers may be present. In contrast, when an element is referred to as being “directly on” or “directly connected to” another element or layer, there are no intervening elements or layers present. As used herein, the term “and/or” includes any and all combinations of one or more of the associated listed items.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Embodiments described herein will be described referring to plan views and/or cross-sectional views by way of ideal schematic views. Accordingly, the exemplary views may be modified depending on manufacturing technologies and/or tolerances. Therefore, the embodiments are not limited to those shown in the views, but include modifications in configuration formed on the basis of manufacturing processes. Therefore, regions exemplified in figures have schematic properties and shapes of regions shown in figures exemplify specific shapes of regions of elements and not limit aspects of the invention.

Hereinafter, an organic light emitting diode display and a driving method thereof in accordance with embodiments invention will be described in detail with reference to the accompanying drawings.

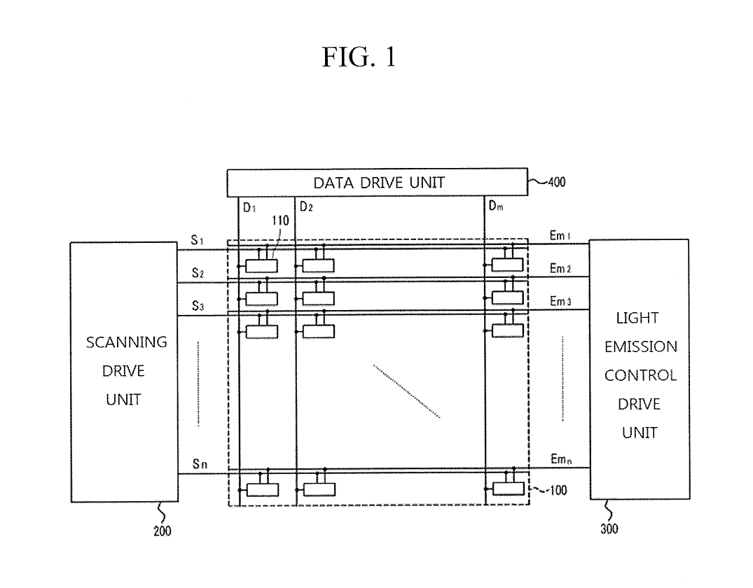

FIG. 1 is a circuit diagram showing an entire configuration of an organic light emitting diode display in accordance with an embodiment. Referring to FIG. 1, the organic light emitting diode display in accordance with the embodiment includes a display region 100, a scanning drive unit 200, connected to the display region 100, that generates a selection signal to be applied to the display region 100, a light emission control drive unit 300, connected to the display region 100, that generates a light emission control signal to be applied to the display region 100, and a data drive unit 400, connected to the display region 100, that applies a data voltage representing a gradation to the display region 100.

The display region 100 may include one or more data lines D1 to Dm, one or more scan lines S1 to Sn, one or more light emission control lines Em1 to Emn, and one or more pixels 110. The respective components may be disposed on a substrate.

The data lines D1 to Dm may extend and constitute one or more columns. The data lines D1 to Dm may serve to apply a data voltage representing a gradation to the pixels 110.

The scan lines S1 to Sn may extend and constitute one or more rows. The scan lines S1 to Sn may serve to apply a selection signal to the pixels 110.

The light emission control lines Em1 to Emn may extend and constitute one or more rows. The light emission control lines Em1 to Emn may serve to apply a light emission control signal to the pixels 110.

The pixels 110 may be disposed at the intersections of the scan lines S1 to Sn and the data lines D1 to Dm. One of the pixels 110 may be connected to one of the scan lines S1 to Sn, and connected to one of the data lines D1 to Dm. That is, one pixel 110 may be defined by a combination of one of the scan lines S1 to Sn and one of the data lines D1 to Dm.

Meanwhile, in order to implement various types of colors, each of the pixels 110 may be configured to fixedly display one color of red (R), green (G) and blue (B), or alternately display the three colors over time. That is, various types of colors can be implemented by a spatial or temporal combination of colors to be displayed by the pixels 110.

In case of implementing colors by a temporal combination, one pixel 110 may alternately display three colors time-divisionally. In case of implementing colors by a spatial combination, one color may be implemented by a combination of three pixels including the pixel 110 representing a red color, the pixel 110 representing a green color, and the pixel 110 representing a blue color.

The data drive unit 400 may be connected to the data lines D1 to Dm of the display region 100. The data drive unit 400 may apply a data voltage representing a gradation to the data lines D1 to Dm.

The scanning drive unit 200 may generate a selection signal consisting of a combination of a gate-on voltage and a gate-off voltage, and sequentially apply the generated selection signal to the scan lines S1 to Sn.

The light emission control drive unit 300 may generate a light emission control signal including a combination of a gate-on voltage and a gate-off voltage, and sequentially apply the generated light emission control signal to the light emission control lines Em1 to Emn.

The scanning drive unit 200, the light emission control drive unit 300, and/or the data drive unit 400 may be disposed as an integrated circuit on the substrate on which the display region 100 is disposed. Alternatively, the scanning drive unit 200, the light emission control drive unit 300, and/or the data drive unit 400 may be formed on the same layer as the layer on which the scan lines S1 to Sn, the light emission control lines Em1 to Emn, the data lines D1 to Dm, and/or the pixels 110 are formed on the substrate on which the display region 100 is disposed, or on a layer adjacent to the layer. Alternatively, the scanning drive unit 200, the light emission control drive unit 300, and/or the data drive unit 400 may be disposed as a chip on a tape carrier package (TCP), a flexible printed circuit (FPC), or a tape automatic bonding (TAB) electrically connected to the substrate on which the display region 100 is disposed.

Although the scanning drive unit 200 and the light emission control drive unit 300 are illustrated separately from each other in FIG. 1, the scanning drive unit 200 and the light emission control drive unit 300 may be formed integrally.

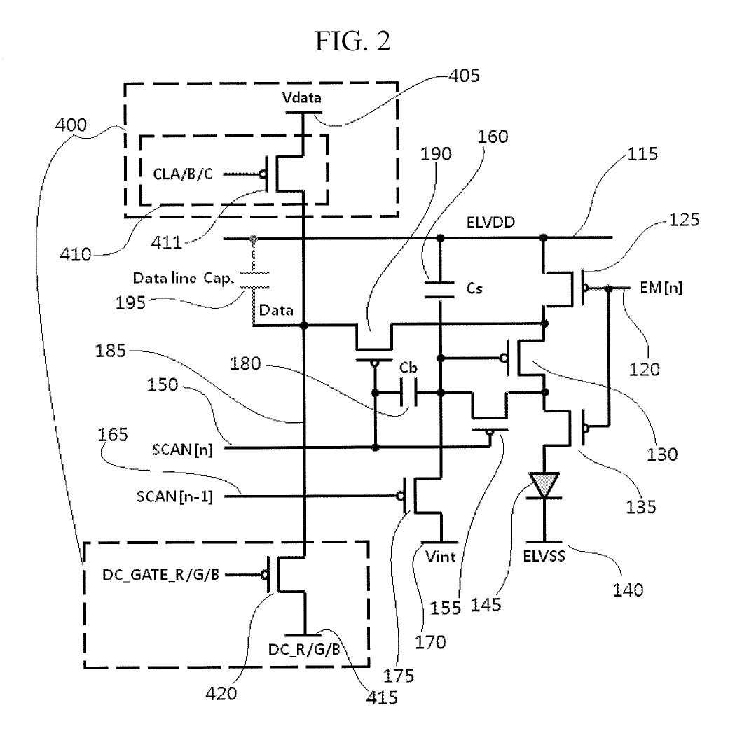

FIG. 2 is a circuit diagram showing a configuration of one pixel circuit of an organic light emitting diode display in accordance with a first embodiment. Referring to FIG. 2, one pixel circuit of the organic light emitting diode display in accordance with the first embodiment may include a first transistor 125, a second transistor 130, a third transistor 135, an organic light emitting element 145, a fourth transistor 155, a first capacitor 160, a fifth transistor 175, a second capacitor 180, a sixth transistor 190, and a third capacitor 195. The first transistor 125 to the eighth transistor 411 may be p-channel metal oxide semiconductor (PMOS) transistors.

The first transistor 125 has a first electrode connected to a first line 115 to which a first voltage is applied and a gate electrode connected to a light emission control line 120. The second transistor 130 has a first electrode of which is connected to a second electrode of the first transistor 125. The third transistor 135 has a first electrode connected to a second electrode of the second transistor 130 and a gate electrode connected to the light emission control line 120. The organic light emitting element 145 has a first end connected to a second electrode of the third transistor 135 and a second end of which is connected to a second line 140 to which a second voltage is applied. The fourth transistor 155 has a first electrode connected to the second electrode of the second transistor 130, a gate electrode connected to a first scan line 150 to which a first selection signal is applied, and a second electrode connected to a gate electrode of the second transistor 130. The first capacitor 160 has a first end connected to the first line 115 and a second end connected to the gate electrode of the second transistor 130. The fifth transistor 175 has a first electrode connected to the gate electrode of the second transistor 130, a gate electrode connected to a second scan line 165 to which a second selection signal is applied before the first selection signal is applied to the first scan line 150, and a second electrode connected to a third line 170 to which a third voltage is applied. The second capacitor 180 has a first end connected to the gate electrode of the second transistor 130 and a second end connected to the first scan line 150. The sixth transistor 190 has a first electrode connected to a first electrode of the second transistor 130, a gate electrode connected to the first scan line 150, and a second electrode connected to a data line 185 to which a data voltage is applied. The third capacitor 195 has a first end connected to the first line 115 and a second end connected to the data line 185.

The first capacitor 160 may serve as a storage capacitor that stores a voltage required to drive the organic light emitting element 145. The second capacitor 180 may serve as a booster capacitor that amplifies a voltage required to drive the organic light emitting element 145. The third capacitor 195 may serve as a data line capacitor that stores a voltage applied to the data line 185. Alternatively, the second capacitor 180 and the third capacitor 195 may be omitted.

Both ends of the data line 185 may be connected to the data drive unit 400. The data drive unit 400 may include a fourth line 405 to which the data voltage is applied, a demultiplexer 410 connected between the fourth line 405 and a first end of the data line 185 to time-divisionally apply the data voltage to the data line 185, a fifth line 415 to which a fourth voltage is applied, and a seventh transistor 420 having a first electrode connected to a second end of the data line 185 and a second electrode connected to the fifth line 415. A control signal may be applied to a gate electrode of the seventh transistor 420.

The demultiplexer 410 may include, as shown in FIG. 2, an eighth transistor 411. The demultiplexer 410 may time-divisionally apply the data voltage applied to the fourth line 405 to the data line 185 according to a demultiplexing signal input to a gate electrode of the eighth transistor 411.

A first voltage ELVDD may be a bipolar voltage. A second voltage ELVSS may be a negative voltage or ground voltage. A third voltage Vint may be a negative voltage or ground voltage. A fourth voltage DC_R/G/B may be a negative voltage or ground voltage. The third voltage Vint and the fourth voltage DC_R/G/B may have the same value, e.g., −2 V.

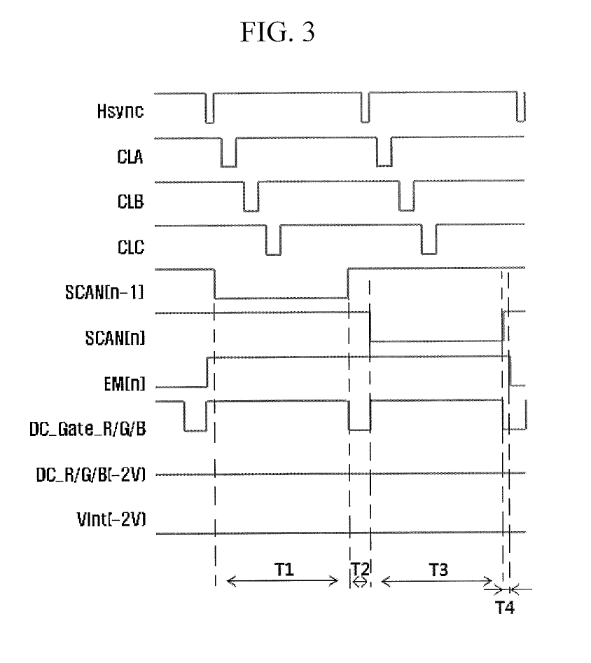

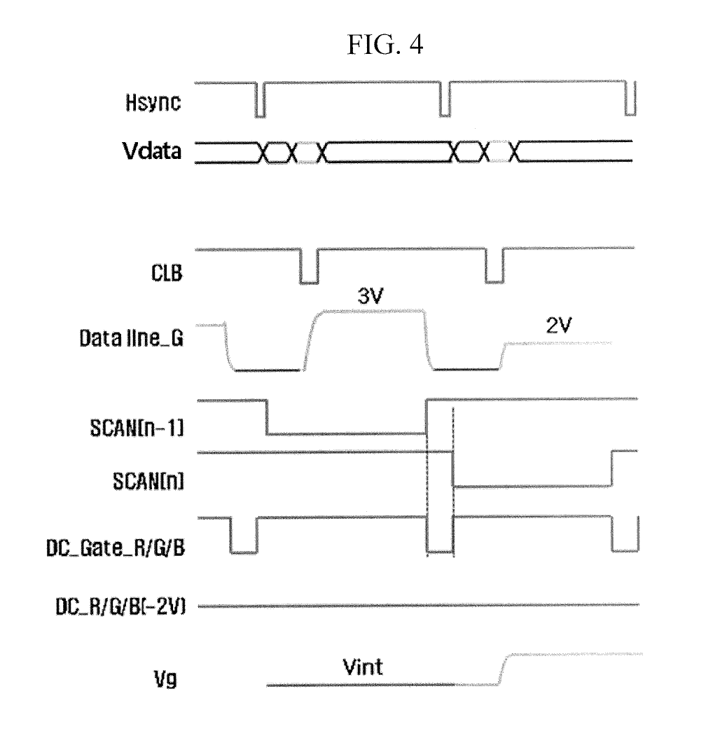

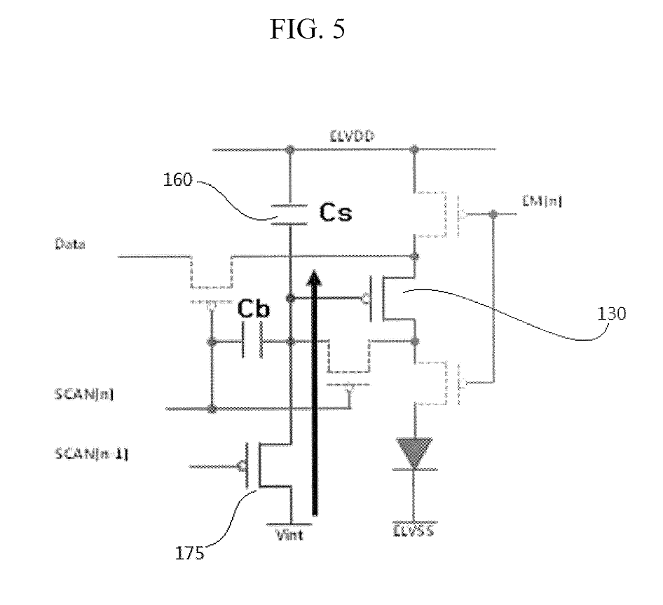

Hereinafter, an operation of the pixel circuit of the organic light emitting diode display in accordance with the first embodiment will be described with reference to FIGS. 3 to 7. FIG. 3 is a waveform diagram showing drive signal timings for the organic light emitting diode display in accordance with the first embodiment. FIG. 4 is a waveform diagram showing drive signal timings for one pixel of the organic light emitting diode display in accordance with the first embodiment. FIGS. 5 to 7 are circuit diagrams for explaining the operation of the pixel circuit in response to the drive signals of the first embodiment.

Referring to FIG. 3, the demultiplexing signals applied to the demultiplexer 410 are represented by CLA, CLB, and CLC. The second selection signal applied to the second scan line 165 is represented by SCAN[n−1]. The first selection signal applied to the first scan line 150 is represented by SCAN[n]. The light emission control signal applied to the light emission control line 120 is represented by EM[n]. The control signal (hereinafter referred to as ‘data initialization signal’) applied to the gate electrode of the seventh transistor 420 is represented by DC_Gat_R/G/B. The fourth voltage applied to the fifth line 415 is represented by DC_R/G/B. The third voltage applied to the third line 170 is represented by Vint. Assuming that the first transistor 125 to the eighth transistor 411 are PMOS transistors, a low level voltage included in each signal may serve as a gate-on voltage, and a high level voltage included in each signal may serve as a gate-off voltage.

FIG. 5 is a circuit diagram for explaining the operation of the pixel circuit in response to the drive signals in period T1 of FIG. 3. Referring to FIG. 3, in the period T1, the light emission control signal EM[n] and the first selection signal SCAN[n] may have a high level, and the second selection signal SCAN[n−1] may have a low level.

Accordingly, as shown in FIG. 5, the first transistor 125, the third transistor 135, the fourth transistor 155, and the sixth transistor 190 may be in a turned-off state. Further, the second transistor 130 and the fifth transistor 175 may be in a turned-on state. Thus, the third voltage Vint may be applied to the gate electrode of the second transistor 130 and the other end of the first capacitor 160. Consequently, the voltage Vg of the gate electrode of the second transistor 130 and the voltage of the other end of the first capacitor 160 may be initialized into the third voltage Vint, i.e., Vg=Vint.

Referring again to FIG. 3, in period T2 after the period T1, the data initialization signal DC_Gate_R/G/B may have a low level, and the light emission control signal EM[n], the first selection signal SCAN[n] and the second selection signal SCAN[n−1] may have a high level.

Accordingly, the first transistor 125 to the sixth transistor 190 may be in a turned-off state. Further, since the seventh transistor 420 is in a turned-on state, the fourth voltage DC_R/G/B may be applied to the data line 185 and the voltage of the second end of the third capacitor 195 may be initialized to the fourth voltage DC_R/G/B.

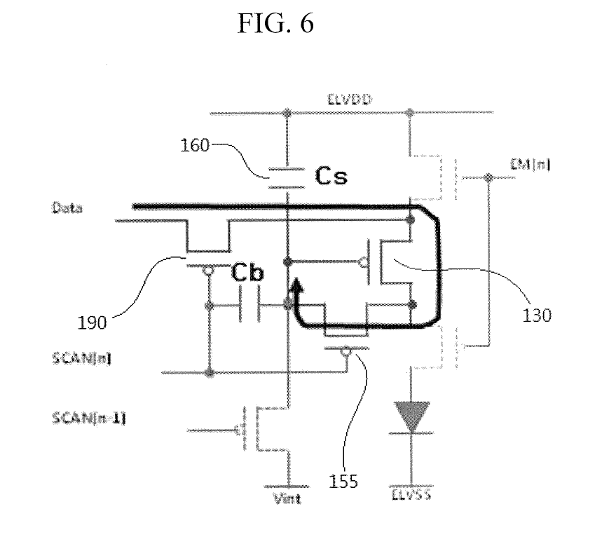

FIG. 6 is a circuit diagram for explaining the operation of the pixel circuit in response to the drive signals in period T3 of FIG. 3. Referring to FIG. 3, in the period T3, the data initialization signal DC_Gate_R/G/B, the light emission control signal EM[n], and the second selection signal SCAN[n−1] may have a high level, and the first selection signal SCAN[n] may have a low level.

Accordingly, as shown in FIG. 6, the first transistor 125, the third transistor 135 and the fifth transistor 175 may be in a turned-off state. Further, the second transistor 130, the fourth transistor 155, and the sixth transistor 190 may be in a turned-on state.

Since the sixth transistor 190 is in the turned-on state, the voltage applied to the data line 185 (hereinafter referred to as ‘data voltage’) or the voltage applied to the second end of the third capacitor 195 may be applied to the first electrode of the second transistor 130. Further, since the second transistor 130 and the fourth transistor 155 are in the turned-on state, the gate electrode and the second electrode of the second transistor 130 may be connected to each other. Accordingly, the second transistor 130 and the fourth transistor 155 may operate as a diode between the second electrode of the first transistor 125 and the other end of the first capacitor 160.

Accordingly, if the data voltage Vdata is larger by at least an absolute value of a threshold voltage Vth of the second transistor 130 than the voltage of the other end of the first capacitor 160 initialized into the third voltage Vint in the period T1, a forward bias may be applied to the equivalent diode. If the forward bias is applied to the equivalent diode, the voltage Vg of the gate electrode of the second transistor 130 and the voltage of the other end of the first capacitor 160 may be smaller by the absolute value of the threshold voltage Vth of the second transistor 130 than the data voltage Vdata, i.e., Vg=Vdata−|Vth|.

If the data voltage Vdata is not larger by at least the absolute value of the threshold voltage Vth of the second transistor 130 than the voltage of the other end of the first capacitor 160 initialized into the third voltage Vint in the period T1, a backward bias may be applied to the equivalent diode. If the backward bias is applied to the equivalent diode, the voltage Vg of the gate electrode of the second transistor 130 and the voltage of the other end of the first capacitor 160 may be maintained.

The waveform diagram shown in FIG. 4 illustrates drive signal timings for a pixel emitting green light. Referring to FIG. 4, the data voltage Vdata applied to the data line 185 is represented by Data line_G.

Referring to the variation of the data voltage Data line_G in FIG. 4, in the period T2, the data voltage Data line_G is initialized into the fourth voltage DC_R/G/B and maintained. In the period T3, if the demultiplexing signal CLB of a low level is applied to the demultiplexer 410, the data voltage (e.g., 2 V) of the fourth line 405 may be applied to the data line 185.

Referring to the variation of the voltage Vg of the gate electrode of the second transistor 130 in FIG. 4, in the period T1, the voltage Vg is initialized into the third voltage Vint and maintained. Since the backward bias is applied to the equivalent diode consisting of the second transistor 130 and the fourth transistor 155 before the data voltage Vdata of the fourth line 405 is applied to the data line 185 by the demultiplexing signal CLB of the low level after the period T3 is started, the voltage Vg of the gate electrode of the second transistor 130 can be maintained. However, since the forward bias is applied to the equivalent diode after the data voltage Vdata of the fourth line 405 is applied to the data line 185 by the demultiplexing signal CLB of the low level, the voltage Vg of the gate electrode of the second transistor 130 may be smaller by the absolute value of the threshold voltage Vth of the second transistor 130 than the data voltage Vdata.

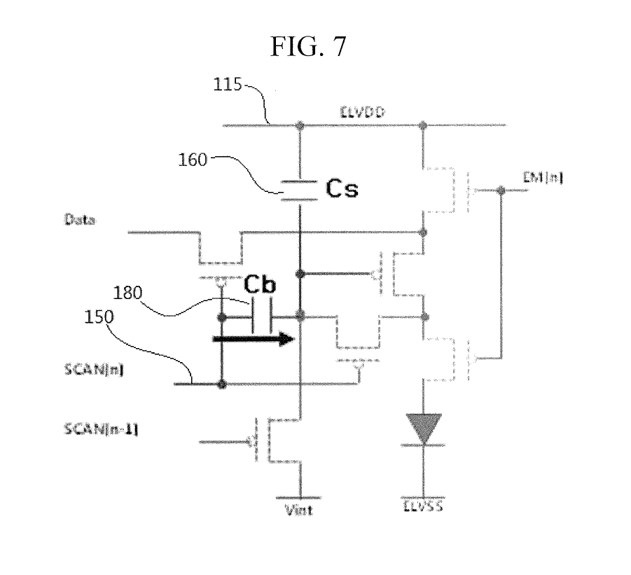

FIG. 7 is a circuit diagram for explaining the operation of the pixel circuit in response to the drive signals in period T4 of FIG. 3. Referring to FIG. 3, in the period T4, the data initialization signal DC_Gate_R/G/B may have a low level, and the light emission control signal EM[n], the first selection signal SCAN[n], and the second selection signal SCAN[n−1] may have a high level.

Accordingly, as shown in FIG. 7, the first transistor 125 to the sixth transistor 190 may be in a turned-off state. Further, as shown in FIG. 7, the first scan line 150, the second capacitor 180, the first capacitor 160, and the first line 115 may be sequentially connected in series. Thus, the voltage Vg of the gate electrode of the second transistor 130 and the voltage of the other end of the first capacitor 160 may be increased by a predetermined ratio of a voltage increment ΔV of the first selection signal SCAN[n]. Specifically, when the capacitance of the first capacitor is referred to as Cs and the capacitance of the second capacitor is referred to as Cb, then Vg=Vdata−|Vth|+ΔV*Cb/(Cs+Cb).

Referring again to FIG. 3, after the period T4, the light emission control signal EM[n] may have a low level. Accordingly, the fourth transistor 155, the fifth transistor 175 and the sixth transistor 190 may be in a turned-off state, and the first transistor 125 and the third transistor 135 may be in a turned-on state.

Thus, the first voltage ELVDD may be applied to the first electrode of the second transistor 130. Further, for a voltage difference Vgs between the gate electrode and the first electrode of the second transistor 130, Vgs=Vg−ELVDD=Vdata−|Vth|+ΔV*Cb/(Cs+Cb)−ELVDD.

Further, if the voltage difference Vgs between the gate electrode and the first electrode of the second transistor 130 is smaller than the threshold voltage Vth of the second transistor 130, the second transistor 130 may be in a turned-on state. If the second transistor 130 is in the turned-on state, a current may flow in a direction toward the second electrode from the first electrode of the second transistor 130. Since the third transistor 135 is in the turned-on state, the current may flow through the organic light emitting element 145. In this case, the organic light emitting element 145 may emit light at brightness that is proportional to the intensity of the current.

The intensity I of the current can be calculated by the following Eq. 1:

$$\begin{matrix}\begin{matrix}I = \frac{k}{2} {( Vgs - Vth )}^{2} \\ = \frac{k}{2} {( Vdata - \vert Vth \vert + Δ V \times \frac{C b}{C s + C b} - ELVDD - Vth )}^{2} \\ = \frac{k}{2} {( Vdata + Δ V \times \frac{C b}{C s + C b} - ELVDD - Vth - ( - Vth ) )}^{2} \\ = \frac{k}{2} {( Vdata + Δ V \times \frac{C b}{C s + C b} - ELVDD )}^{2}\end{matrix} & Eq . 1\end{matrix}$$

In the above Eq. 1, k may be a constant that is determined by the oxide layer capacitance, the carrier mobility, the channel length, and the channel width of the second transistor 130 and the like.

Referring to the above Eq. 1, it can be seen that the current flowing through the organic light emitting element 145 is affected only by the data voltage Vdata regardless of the threshold voltage Vth of the second transistor 130. Accordingly, a deviation of the threshold voltage Vth of the second transistor 130 may be compensated.

According to the first embodiment, as shown in FIG. 3, the periods in which demultiplexing signals CLA, CLB, and CLC of the low level are applied and the period in which the first selection signal SCAN[n] of the low level is applied may overlap each other in one horizontal cycle. Alternatively, the periods in which the demultiplexing signals CLA, CLB, and CLC of the low level are applied and the period in which the second selection signal SCAN[n−1] is applied may overlap each other in one horizontal cycle.

In the embodiment shown in FIG. 3, in one horizontal cycle, a start point of the period in which the first selection signal SCAN[n] or the second selection signal SCAN[n−1] is applied is prior to a start point of the first period CLA among a plurality of periods CLA, CLB, and CLC in which the demultiplexing signals CLA, CLB, and CLC are applied. However, in some embodiments, in one horizontal cycle, a start point of the period in which the first selection signal SCAN[n] or the second selection signal SCAN[n−1] is applied may be equal to or prior to a start point of any period among a plurality of periods CLA, CLB, and CLC in which the demultiplexing signals CLA, CLB, and CLC are applied.

In one horizontal cycle, an end point of the period in which the first selection signal SCAN[n] or the second selection signal SCAN[n−1] is applied may be equal to or later than an end point of the last period among a plurality of periods CLA, CLB, and CLC in which the demultiplexing signals CLA, CLB, and CLC are applied.

Further, in one horizontal cycle, the data initialization signal DC_Gate_R/G/B of the low level may be applied before the period in which the second selection signal SCAN[n−1] of the low level is applied after the period in which the first selection signal SCAN[n] of the low level is applied.

According to the first embodiment, as shown in FIG. 3, by ensuring enough time to apply the first selection signal SCAN[n] or the second selection signal SCAN[n−1] of the low level, it is possible to approximate the voltage Vg of the gate electrode of the second transistor 130 to be smaller by the absolute value of the threshold voltage Vth of the second transistor 130 than the data voltage Vdata. Differently from the case shown in FIG. 3, if the periods in which the demultiplexing signals CLA, CLB and CLC of the low level are applied and the period in which the first selection signal SCAN[n] of the low level is applied do not overlap each other, and the first selection signal SCAN[n] of the low level is applied after the periods in which the demultiplexing signals CLA, CLB and CLC of the low level are applied, the voltage Vg of the gate electrode of the second transistor 130 may not be sufficiently smaller than the data voltage Vdata.

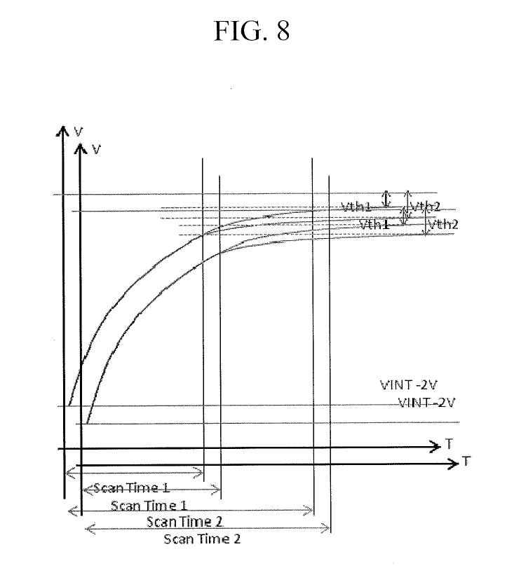

FIG. 8 is a time-voltage graph for explaining the effect of the organic light emitting diode display in accordance with the first embodiment. In the graph of FIG. 8, an X axis represents the time in the period T3 and a Y axis represents the results of measuring the voltage Vg of the gate electrode of the second transistor 130.

Referring to FIG. 8, the period indicated by “Scan Time 1” and its corresponding graph Vth1 show a case where the periods in which the demultiplexing signals CLA, CLB, and CLC of the low level are applied and the period in which the first selection signal SCAN[n] of the low level is applied do not overlap each other, and the first selection signal SCAN[n] of the low level is applied after the periods in which the demultiplexing signals CLA, CLB, and CLC of the low level are applied. Further, the period indicated by “Scan Time 2” and its corresponding graph Vth2 show a case where the periods in which the demultiplexing signals CLA, CLB, and CLC of the low level are applied and the period in which the first selection signal SCAN[n] of the low level is applied overlap each other as in the first embodiment.

As shown in FIG. 8, in the case where the first selection signal SCAN[n] of the low level is applied after the periods in which the demultiplexing signals CLA, CLB, and CLC of the low level are applied, the voltage Vg of the gate electrode of the second transistor 130 may not be sufficiently smaller than the data voltage Vdata. However, in the case where the periods in which the demultiplexing signals CLA, CLB, and CLC of the low level are applied and the period in which the first selection signal SCAN[n] of the low level is applied overlap each other, the voltage Vg of the gate electrode of the second transistor 130 may be sufficiently smaller than the data voltage Vdata. Accordingly, the compensation of the threshold voltage can be more accurately performed and the image quality of the organic light emitting diode display can be improved.

Differently from the case shown in FIG. 3, if the data initialization signal DC_Gate_R/G/B of the low level is not applied before the period in which the second selection signal SCAN[n−1] of the low level is applied after the period in which the first selection signal SCAN[n] of the low level is applied, a problem may occur. In other words, if the voltage applied to the data line 185 is not initialized at least before the period in which the second selection signal SCAN[n−1] of the low level is applied, a problem may occur.

That is, in the period T1 of FIG. 3, the data voltage Vdata for a previous frame may be applied to the data line 185 by the demultiplexing signals CLA, CLB, and CLC of the low level. The data voltage Vdata can be maintained in the data line 185 before the demultiplexing signals CLA, CLB, and CLC of the low level are applied after the period T3 is started. At this time, since the first selection signal SCAN[n] of the low level is applied with the start of the period T3, the data voltage Vdata for the previous frame may be applied to the other end of the first capacitor 160 as described with reference to FIG. 6. Then, the data voltage Vdata for a current frame may be applied to the data line 185 by the demultiplexing signals CLA, CLB, and CLC of the low level in the period T3.

However, if the data voltage Vdata for the current frame is smaller than the data voltage Vdata for the previous frame, the data voltage Vdata for the current frame may be insufficient to apply a forward bias to the equivalent diode formed by the second transistor 130 and the fourth transistor 155. In this case, the voltage applied to the other end of the first capacitor 160 may be maintained at a voltage corresponding to the data voltage Vdata for the previous frame, and non-uniformity in brightness may occur since the screen is not updated.

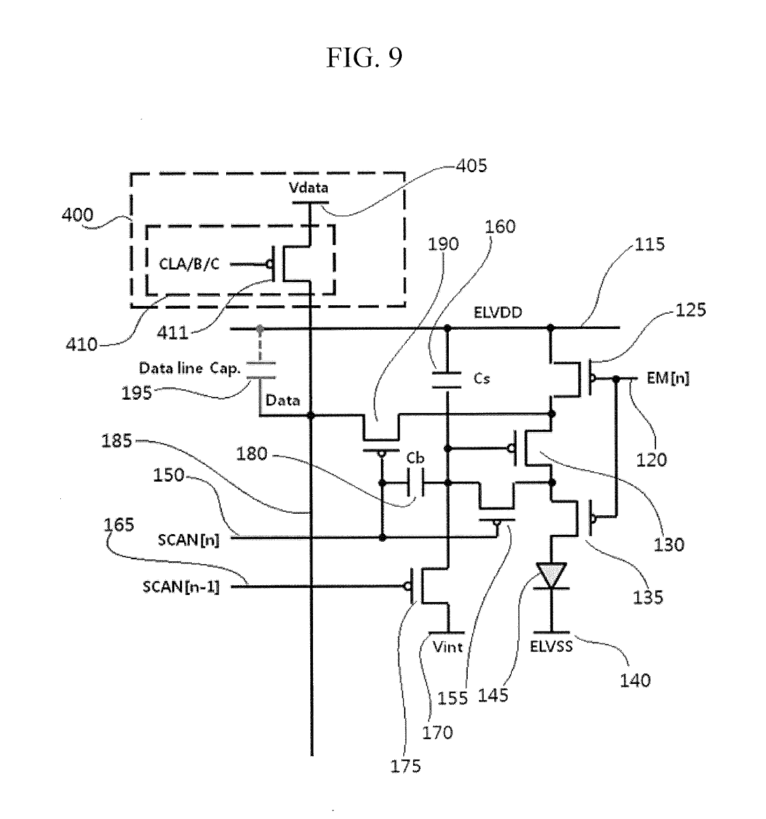

FIG. 9 is a circuit diagram showing a configuration of one pixel circuit of an organic light emitting diode display in accordance with a second embodiment. In the second embodiment, the fifth line 415 and the seventh transistor 420 of the data drive unit 400 shown in FIG. 2 are not used. Thus, in the circuit diagram shown in FIG. 9, the fifth line 415 and the seventh transistor 420 are omitted. However, the fifth line 415 and the seventh transistor 420 may be included.

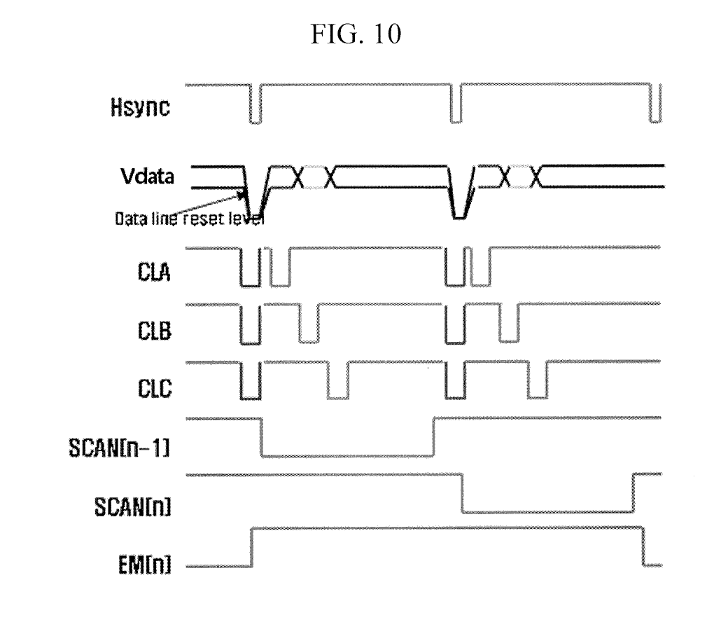

FIG. 10 is a waveform diagram showing drive signal timings for the organic light emitting diode display in accordance with the second embodiment. Referring to FIG. 10, since the timings of the demultiplexing signals CLA, CLB, and CLC, the first selection signal SCAN[n], the second selection signal SCAN[n−1], and the light emission control signal EM[n] are the same as those of the first embodiment, a description thereof will not be repeated.

In the first embodiment, the voltage of the data line 185 is initialized by applying the data initialization signal DC_Gate_R/G/B of the low level before the period in which the second selection signal SCAN[n−1] of the low level is applied after the period in which the first selection signal SCAN[n] of the low level is applied. On the other hand, in the second embodiment, the voltage applied to the data line 185 may be initialized by applying a voltage for initialization to the fourth line 405 without using the data initialization signal DC_Gate_R/G/B.

Referring to FIG. 10, the voltage for initialization may be applied to the fourth line 405 before the period in which the second selection signal SCAN[n−l] of the low level is applied after the period in which the first selection signal SCAN[n] of the low level is applied. That is, during a period corresponding to the period T2 of FIG. 3, the voltage for initialization may be applied to the fourth line 405. The voltage for initialization may be a negative voltage or ground voltage. The voltage for initialization may be, e.g., −2 V. Further, during the period corresponding to the period T2 of FIG. 3, the demultiplexing signals CLA, CLB, and CLC of the low level may be applied to all demultiplexers 410.

Thus, according to the second embodiment, during the period corresponding to the period T2 of FIG. 3, the voltage for initialization may be applied from the fourth line 405 to all data lines 185 by the demultiplexing signals CLA, CLB, and CLC of the low level. Accordingly, during the period corresponding to the period T2 of FIG. 3, the voltage applied to the data line 185 can be initialized even without using the data initialization signal DC_Gate_R/G/B as in the first embodiment.

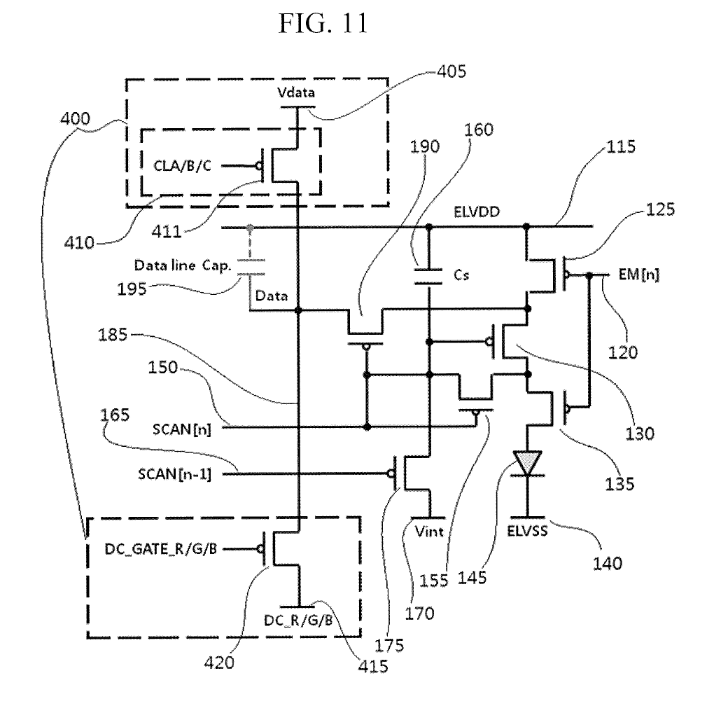

FIG. 11 is a circuit diagram showing a configuration of one pixel circuit of an organic light emitting diode display in accordance with a third embodiment.

Referring to FIG. 11, the pixel circuit of the organic light emitting diode display in accordance with the third embodiment may not include the second capacitor 180 differently from the pixel circuit of the first embodiment shown in FIG. 2. Accordingly, in the period T4 of FIG. 3, the voltage Vg of the gate electrode of the second transistor 130 and the voltage of the other end of the first capacitor 160 may not increase differently from the first embodiment. Thus, during the period T4 of FIG. 3, Vg=Vdata−|Vth|.

After the period T4 of FIG. 3, the light emission control signal EM[n] may have a low level. Accordingly, the fourth transistor 155, the fifth transistor 175 and the sixth transistor 190 may be in a turned-off state, and the first transistor 125 and the third transistor 135 may be in a turned-on state.

Accordingly, the first voltage ELVDD may be applied to the first electrode of the second transistor 130. Further, for the voltage difference Vgs between the gate electrode and the first electrode of the second transistor 130, the equation Vgs=Vg−ELVDD=Vdata−|Vth|−ELVDD can be established.

Further, if the voltage difference Vgs between the gate electrode and the first electrode of the second transistor 130 is smaller than the threshold voltage Vth of the second transistor 130, the second transistor 130 may be in a turned-on state. If the second transistor 130 is in the turned-on state, a current may flow in a direction toward the second electrode from the first electrode of the second transistor 130. Since the third transistor 135 is in the turned-on state, the current may flow through the organic light emitting element 145. In this case, the organic light emitting element 145 may emit light at brightness that is proportional to the intensity of the current.

The intensity I of the current can be calculated by the following Eq. 2:

$$\begin{matrix}I = \frac{k}{2} {( Vgs - Vth )}^{2} \\ = \frac{k}{2} {( Vdata - \vert Vth \vert - ELVDD - Vth )}^{2} \\ = \frac{k}{2} {( Vdata - ELVDD - Vth - ( - Vth ) )}^{2} \\ = \frac{k}{2} {( Vdata - ELVDD )}^{2}\end{matrix} \qquad Eq . 2$$

According to the third embodiment, since the second capacitor 180 may not be disposed separately, the structure of the pixel circuit maybe further simplified. Since the remaining configuration is the same as that of the first embodiment, a description thereof will not be repeated.

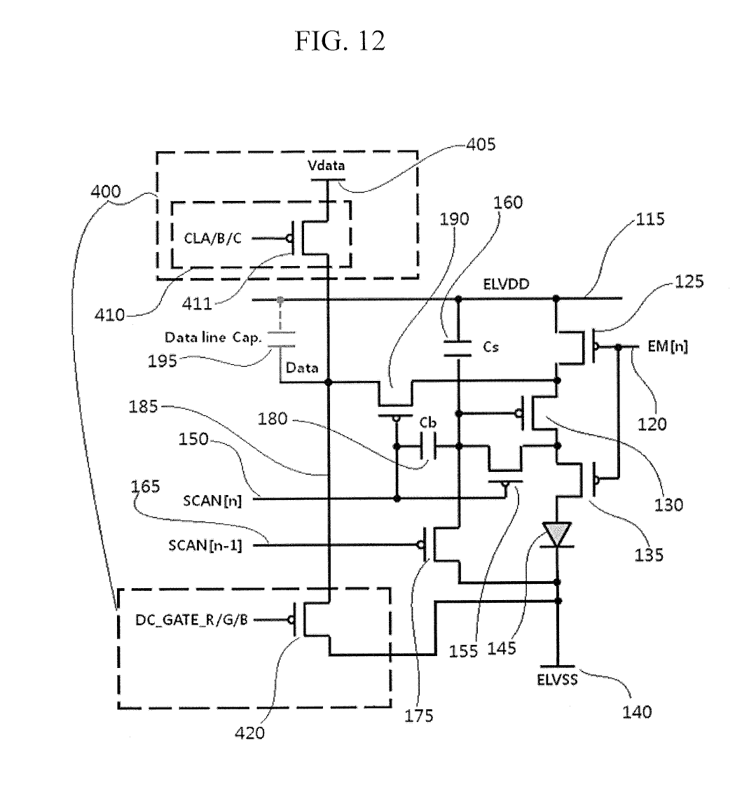

FIG. 12 is a circuit diagram showing a configuration of one pixel circuit of an organic light emitting diode display in accordance with a fourth embodiment.

Referring to FIG. 12, the pixel circuit of the organic light emitting diode display in accordance with the fourth embodiment may not include the third line 170 and the fifth line 415 differently from the pixel circuit of the first embodiment shown in FIG. 2. Further, the second electrode of the fifth transistor 175 may be connected to the second line 140 and the second electrode of the seventh transistor 420 may be connected to the second line 140.

The second voltage ELVSS applied to the second line 140 may be smaller than the lowest data voltage Vdata that can be applied to the data line 185. For example, the second voltage ELVSS may be a negative voltage or ground voltage.

According to the fourth embodiment, since the third line 170 and the fifth line 415 may not be disposed separately, an area occupied by the pixel circuit may be reduced. Further, since a circuit for generating the third voltage Vint and the fourth voltage DC_R/G/B may not disposed separately, the structure of a power supply unit may be simplified. Since the remaining configuration is the same as that of the first embodiment, a description thereof will not be repeated.

In the above-described organic light emitting diode display according to one or more embodiments, it is possible to more accurately compensate for the threshold voltage of the drive transistor. Further, in the organic light emitting diode display according to one or more embodiments, it is possible to stably compensate for the threshold voltage of the drive transistor even in the high resolution and high frequency environment. Further, in the organic light emitting diode display according to one or more embodiments, it is possible to ensure the time required to compensate for the threshold voltage of the drive transistor even in the high resolution and high frequency environment.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. An organic light emitting diode display, comprising:
at least one pixel circuit;
a scanning drive unit connected to the pixel circuit through a scan line, the scanning drive unit being configured to generate a selection signal to be applied to the pixel circuit; and
a data drive unit connected to the pixel circuit through a data line, the data drive unit being configured to apply a data voltage to the pixel circuit,
wherein the data drive unit includes a first line to which the data voltage is applied and a demultiplexer connected between the first line and a first end of the data line, the demultiplexer being configured to time-divisionally apply the data voltage applied to the first line to the data line according to a demultiplexing signal, and
wherein, in one horizontal cycle, at least a portion of a period in which the demultiplexing signal is applied and at least a portion of a period in which the selection signal is applied overlap each other.

2. The organic light emitting diode display of claim 1, wherein, in the one horizontal cycle, a start point of a period in which the selection signal is applied is equal to or prior to a start point of any period among at least one period in which the demultiplexing signal is applied, and an end point of a period in which the selection signal is applied is equal to or later than an end point of the last period among at least one period in which the demultiplexing signal is applied.

3. The organic light emitting diode display of claim 1, wherein:
the scan line includes a first scan line to which a first selection signal is applied and a second scan line to which a second selection signal is applied before the first selection signal is applied to the first scan line, and
a negative voltage or ground voltage is applied to the data line before a period in which the first selection signal is applied after a period in which the second selection signal is applied.

4. The organic light emitting diode display of claim 1, wherein:
the scan line includes a first scan line to which a first selection signal is applied and a second scan line to which a second selection signal is applied before the first selection signal is applied to the first scan line,
a negative voltage or ground voltage is applied to the first line before a period in which the first selection signal is applied after a period in which the second selection signal is applied, and
the demultiplexing signal is applied to the demultiplexer before the period in which the first selection signal is applied after the period in which the second selection signal is applied.

5. The organic light emitting diode display of claim 1, further comprising:
a light emission control drive unit connected to the pixel circuit through a light emission control line, the light emission control drive unit configured to generate a light emission control signal to be applied to the pixel circuit;
a second line connected to the pixel circuit and to which a first voltage is applied;
a third line connected to the pixel circuit and to which a second voltage is applied; and
a fourth line connected to the pixel circuit and to which a third voltage is applied,
wherein the scan line includes a first scan line to which a first selection signal is applied and a second scan line to which a second selection signal is applied before the first selection signal is applied to the first scan line, and
wherein the pixel circuit includes:
a first switching element having a first electrode connected to the second line and a gate electrode connected to the light emission control line;
a second switching element having a first electrode connected to a second electrode of the first switching element;
a third switching element having a first electrode connected to a second electrode of the second switching element and a gate electrode connected to the light emission control line;
an organic light emitting element having a first end connected to a second electrode of the third switching element and a second end connected to the third line to which the second voltage is applied;
a fourth switching element has a first electrode connected to the second electrode of the second switching element, a gate electrode connected to the first scan line, and a second electrode connected to a gate electrode of the second switching element;
a first capacitor having a first end connected to the second line and a second end connected to the gate electrode of the second switching element;
a fifth switching element having a first electrode connected to the gate electrode of the second switching element, a gate electrode connected to the second scan line, and a second electrode connected to the fourth line; and
a sixth switching element having a first electrode connected to a first electrode of the second switching element, a gate electrode connected to the first scan line, and a second electrode connected to the data line.

6. The organic light emitting diode display of claim 5, wherein the data drive unit further includes a fifth line to which a fourth voltage is applied and a seventh switching element having a first electrode connected to the other end of the data line and a second electrode connected to the fifth line.

7. The organic light emitting diode display of claim 6, wherein a control signal is applied to a gate electrode of the seventh switching element before a period in which the first selection signal is applied after a period in which the second selection signal is applied.

8. The organic light emitting diode display of claim 6, wherein the fourth voltage is applied to the data line when a control signal is applied to the gate electrode of the seventh switching element.

9. The organic light emitting diode display of claim 6, wherein the first voltage is a bipolar voltage, the second voltage is a negative voltage or ground voltage, the third voltage is a negative voltage or ground voltage, and the fourth voltage is a negative voltage or ground voltage.

10. The organic light emitting diode display of claim 6, wherein the first switching element to the seventh switching element are p-channel metal oxide semiconductor (PMOS) transistors.

11. The organic light emitting diode display of claim 5, further comprising a second capacitor having a first end connected to the gate electrode of the second switching element and a second end connected to the first scan line.

12. The organic light emitting diode display of claim 5, further comprising a third capacitor having a first end connected to the second line and a second end connected to the data line.

13. The organic light emitting diode display of claim 1, further comprising:
a light emission control drive unit connected to the pixel circuit through a light emission control line, the a light emission control drive unit being configured to generate a light emission control signal to be applied to the pixel circuit;
a second line connected to the pixel circuit and to which a first voltage is applied; and
a third line connected to the pixel circuit and to which a second voltage is applied,
wherein the data drive unit further includes a seventh switching element having a first electrode connected to the second end of the data line and a second electrode connected to the second line,
wherein the scan line includes a first scan line to which a first selection signal is applied and a second scan line to which a second selection signal is applied before the first selection signal is applied to the first scan line, and
wherein the pixel circuit includes:
a first switching element having a first electrode connected to the second line and a gate electrode connected to the light emission control line;
a second switching element having a first electrode connected to a second electrode of the first switching element;
a third switching element having a first electrode connected to a second electrode of the second switching element and a gate electrode connected to the light emission control line;
an organic light emitting element having a first end connected to a second electrode of the third switching element and a second end connected to the third line to which the second voltage is applied;
a fourth switching element having a first electrode connected to the second electrode of the second switching element, a gate electrode connected to the first scan line, and a second electrode connected to a gate electrode of the second switching element;
a first capacitor having a first end connected to the second line and a second end connected to the gate electrode of the second switching element;
a fifth switching element having a first electrode connected to the gate electrode of the second switching element, a gate electrode connected to the second scan line, and a second electrode connected to the second line; and
a sixth switching element having a first electrode connected to a first electrode of the second switching element, a gate electrode connected to the first scan line, and a second electrode connected to the data line.

14. An organic light emitting diode display, comprising:
a storage capacitor whose stored voltage is initialized according to a first selection signal; and
a data line connected to the storage capacitor and to which a data voltage is applied according to a demultiplexing signal,
wherein the storage capacitor stores the data voltage applied to the data line according to a second selection signal, and
wherein, in one horizontal cycle, at least a portion of a period in which the demultiplexing signal is applied and at least a portion of a period in which the first selection signal or the second selection signal is applied overlap each other.

15. The organic light emitting diode display of claim 14, wherein in the one horizontal cycle, a start point of a period in which the second selection signal is applied is equal to or prior to a start point of any period among at least one period in which the demultiplexing signal is applied, and an end point of a period in which the second selection signal is applied is equal to or later than an end point of the last period among at least one period in which the demultiplexing signal is applied.

16. A driving method of an organic light emitting diode display, comprising:
initializing a voltage stored in a capacitor included in a pixel circuit according to a first selection signal;
applying a data voltage to a data line according to a demultiplexing signal; and
storing the data voltage applied to the data line in the capacitor according to a second selection signal,
wherein, in one horizontal cycle, at least a portion of a period in which the demultiplexing signal is applied and at least a portion of a period in which the first selection signal or the second selection signal is applied overlap each other.

17. The driving method of claim 16, wherein, in the one horizontal cycle, a start point of the period in which the second selection signal is applied is equal to or prior to a start point of any period among at least one period in which the demultiplexing signal is applied, and an end point of the period in which the second selection signal is applied is equal to or later than an end point of the last period among at least one period in which the demultiplexing signal is applied.

18. The driving method of claim 16, further comprising, before storing the data voltage in the capacitor after initializing the voltage stored in the capacitor, applying a negative voltage or ground voltage to the data line.

19. The driving method of claim 16, wherein applying the data voltage to the data line comprises:
applying a negative voltage or ground voltage to the data line according to a first demultiplexing signal; and
applying a data voltage representing a gradation to the data line according to a second demultiplexing signal,
wherein, in the one horizontal cycle, at least a portion of a period in which the second demultiplexing signal is applied and at least a portion of a period in which the first selection signal or the second selection signal is applied overlap each other.

20. The driving method of claim 19, further comprising, before storing the data voltage in the capacitor after initializing the voltage stored in the capacitor, applying a negative voltage or ground voltage to the data line according to the first demultiplexing signal.
